(19) United States
(12) Patent Application Publication
(10) Pub. No.: US 2018/0356886 A1
(43) Pub. Date: Dec. 13, 2018

(54) VIRTUAL REALITY DISPLAY SYSTEM AND DISPLAY DRIVING APPARATUS

(71) Applicant: Raydium Semiconductor Corporation, Hsinchu (TW)

(72) Inventor: Hung LI, Taipei City (TW)

(21) Appl. No.: 16/002,141

(22) Filed: Jun. 7, 2018

Related U.S. Application Data
(60) Provisional application No. 62/516,705, filed on Jun. 8, 2017.

(51) Int. Cl. G06F 3/01; G06T 5/00; G06T 5/50; G06T 19/20

(52) U.S. Cl. CPC G06F 3/013; G06T 5/001; G06T 2219/2016; G06T 19/20; G06T 5/50

(57) ABSTRACT

A virtual reality display system is disclosed. The virtual reality display system includes a front-end image processing apparatus, a display driving apparatus and a panel. The front-end image processing apparatus is used to perform partition image processing on a first image according to an eye tracking information and then output a second image and a partition information. The partition information is related to the eye tracking information and the first image. A second data volume of the second image is smaller than a first volume of the first image. The display driving apparatus is coupled to the front-end image processing apparatus and used to restore the second image to the first image. The panel is coupled to the display driving apparatus and used to display the first image.

### BACKGROUND OF THE INVENTION

### 1. Field of the invention

The invention relates to a display technology of virtual reality; in particular, to a virtual reality display system and a display driving apparatus.

### 2. Description of the prior art

A head-mounted virtual reality display apparatus currently on the market is subject to restrictions such as high hardware requirements and high prices, leading to a low degree of popularity in the consumer market. In order to reduce the requirements of the virtual reality technology for computing performance of computers, the industry proposes various solutions, such as “foveated rendering” that simulates human vision and the latest 250 Hz eye tracking device used in the head-mounted virtual reality display apparatus attracting most attentions.

Since human eye does not notice all details when viewing an object displayed by the panel, only the vicinity of the visual focus near the middle position will be clear. Therefore, the so-called “gaze position rendering technology” is to process only the gaze position of the image displayed on the panel that is actually gazed by human eye instead of wasting the computing capability of the computer at the position where the human eye is not looking at, so that the computing burden of the computer can be effectively reduced and the requirements of the virtual reality technology for computer computing performance can be also reduced to effectively increase the degree of popularity of the virtual reality display apparatus in the consumer market.

In detail, the “gaze position rendering technique” is used to divide the image displayed by the panel into three regions: a visual center, a visual edge and an intermediate transition region based on the eye tracking information and then perform rendering on the visual center, the visual edge and the intermediate transition region with different resolutions respectively, such as rendering with resolutions of 100%, 20% and 60% respectively to significantly reduce the operation amount of the computer.

However, although the currently used “gaze position rendering technology” can effectively improve the processing efficiency of the computer, a large amount of image data still needs to be transmitted to the transmission interface of the display driving apparatus (e.g., a panel display driving IC). Especially, under the condition that the panel will have higher resolution and frame rate in the future, the data transmission interface will inevitably face the problem of insufficient bandwidth and its data transmission speed will be also limited. Therefore, it is urgent to solve these problems.

### SUMMARY OF THE INVENTION

Therefore, the invention provides a virtual reality display system and a display driving apparatus to solve the above-mentioned problems of the prior arts.

A preferred embodiment of the invention is a virtual reality display system. In this embodiment, the virtual reality display system includes a front-end image processing apparatus, a display driving apparatus and a panel. The front-end image processing apparatus is used for performing a partition image processing on a first image according to an eye tracking information and then outputting a second image and a partition information, wherein the partition information is related to the eye tracking information and the first image, and a second data volume of the second image is smaller than a first volume of the first image. The display driving apparatus is coupled to the front-end image processing apparatus and used for restoring the second image to the fist image according to the partition information. The panel is coupled to the display driving apparatus and used for displaying the first image.

In an embodiment, the front-end image processing apparatus includes an eye tracking module, a partition processing module and a transmission module. The eye tracking module is used for tracking a gaze position on the panel when human eyes gaze on the panel and generating the eye tracking information according to the gaze position. The partition processing module is coupled to the eye tracking module and used for receiving the first image and the eye tracking information respectively and performing the partition image processing on the first image according to an eye tracking information to generate the second image and the partition information. The transmission module is coupled to the partition processing module and the display driving apparatus respectively and used for transmitting the second image and the partition information to the display driving apparatus.

In an embodiment, the partition image processing includes performing a data volume reduction processing on the first data volume of the first image.

In an embodiment, the display driving apparatus includes a receiving module, an image restoring module and a driving module. The receiving module is coupled to the front-end image processing apparatus and used for receiving the second image and the partition information. The image restoring module is coupled to the receiving module and used for restoring the second image to the first image according to the partition information. The driving module is coupled to the image restoring module and the panel and used for generating a driving signal including the first image to the panel to drive the panel to display the first image.

In an embodiment, the image restoring module performs a data volume restoring processing on the second data volume of the second image.

In an embodiment, the virtual reality display system includes a transmission interface. The transmission interface is coupled between the front-end image processing apparatus and the display driving apparatus and used for transmitting the second image and the partition information.

Another preferred embodiment of the invention is a display driving apparatus. In this embodiment, the display driving apparatus is applied to a virtual reality display system and coupled between a front-end image processing apparatus and a panel. The front-end image processing apparatus performs a partition image processing on a first image according to an eye tracking information and then outputting a second image and a partition information to the display driving apparatus, the partition information is related to the eye tracking information and the first image, and a second data volume of the second image is smaller than a first volume of the first image. The display driving apparatus includes a receiving module, an image restoring module and a driving module. The receiving module is coupled to the front-end image processing apparatus and used for receiving the second image and the partition information. The image restoring module is coupled to the receiving module and used for restoring the second image to the first image according to the partition information. The driving module is coupled to the image restoring module and the panel and used for generating a driving signal including the first image to the panel to drive the panel to display the first image.

Compared to the prior art, in the virtual reality display system of the invention, the front-end image processing apparatus can be divided into a gaze region and a non-gaze region by using the gaze position on the panel obtained by the eye tracking module and different number of bits and resolutions can be provided to the gaze region and the non-gaze region respectively, such as the higher number of bits and resolution are only provided to the gaze region, while a lower number of bits and resolution are provided to the non-gaze region. In this way, the front-end image processing apparatus can greatly reduce the data volume of the image and then transmit it to the display driving apparatus through the transmission interface. Therefore, the bandwidth required for the transmission interface to transmit the display image can be effectively saved, thereby the insufficient bandwidth of the data transmission interface can be improved and good data transmission speed can be maintained.

The advantage and spirit of the invention may be understood by the following detailed descriptions together with the appended drawings.

### BRIEF DESCRIPTION OF THE APPENDED DRAWINGS

FIG. 1 illustrates a functional block diagram of the virtual reality display system in a preferred embodiment of the invention.

FIG. 2 illustrates a schematic diagram of the visual angles of the surrounding scenery (e.g., text, shape, color, etc.) recognized by the user' eyes.

FIG. 3 illustrates a schematic diagram of dividing a panel into display regions centering on a first gaze position on the panel when the human eyes gaze the panel.

FIG. 4 illustrates a schematic diagram of obtaining the widths of different display regions according to the horizontal visual angle of the human eyes and the distance between the human eyes and the panel.

FIG. 5 illustrates a schematic diagram of obtaining the heights of different display regions according to the vertical visual angle of the human eyes and the distance between the human eyes and the panel.

FIG. 6 illustrates a schematic diagram of dividing the panel into display regions centering on the second gaze position when the position on the panel gazed by the human eyes is moved from the original first gaze position to the second gaze position.

FIG. 7 illustrates a schematic diagram of obtaining the widths of different display regions according to the horizontal visual angle of the human eyes and the distance between the human eyes and the panel.

FIG. 8 illustrates a schematic diagram of obtaining the heights of different display regions according to the vertical visual angle of the human eyes and the distance between the human eyes and the panel.

### DETAILED DESCRIPTION OF THE INVENTION

A preferred embodiment of the invention is a virtual reality display system. In fact, the virtual reality display system can be a head-mounted virtual reality display apparatus; that is to say, the user can wear the virtual reality display system and its panel can be disposed corresponding to the user's eyes, so that the user can view the images displayed by the panel, but not limited to this.

In this embodiment, the virtual reality display system can divide the entire display region of the panel into a gaze region and a non-gaze region according to a gaze position on the panel when the human eyes gaze the panel and provide different number of bits and resolutions to the gaze region and the non-gaze region respectively to reduce the data volume of the display image and then transmit it to the display driving apparatus through the data transmission interface. Therefore, it can save the bandwidth required for the data transmission interface to transmit the display image and maintain good data transmission speed.

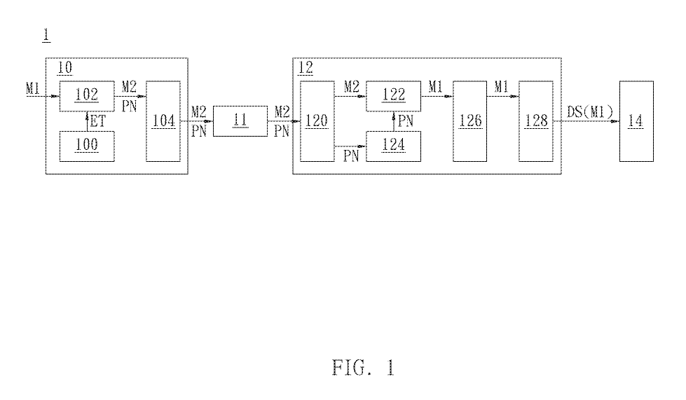

Please refer to FIG. 1. FIG. 1 illustrates a functional block diagram of the virtual reality display system in this embodiment. As shown in FIG. 1, the virtual reality display system 1 can include a front-end image processing apparatus 10, a transmission interface 11, a display driving apparatus 12 and a panel 14. Wherein, the transmission interface 11 is coupled between the front-end image processing apparatus 10 and the display driving apparatus 12; the display driving apparatus 12 is coupled to the panel 14.

The front-end image processing apparatus 10 is used for performing a partition image processing on a first image M1 according to an eye tracking information ET and then outputting a second image M2 and a partition information PN. It should be noticed that the partition information PN is related to the eye tracking information ET and the first image Ml, and a second data volume of the second image M2 is smaller than a first volume of the first image M1.

In this embodiment, the front-end image processing apparatus 10 can include an eye tracking module 100, a partition processing module 102 and a transmission module 104. The eye tracking module 100 is coupled to the partition processing module 102; the partition processing module 102 is coupled to the transmission module 104; the transmission module 104 is coupled to the transmission interface 11.

The eye tracking module 100 is used for tracking a gaze position on the panel 14 when the human eyes gaze on the panel 14 and generating the eye tracking information ET to the partition processing module 102 according to the gaze position.

The partition processing module 102 is used for receiving the first image M1 and the eye tracking information ET respectively and performing the partition image processing on the first image M1 according to an eye tracking information ET to generate the second image M2 and the partition information PN. Then, the transmission module 104 will transmit the second image M2 and the partition information PN to the display driving apparatus 12.

When the display driving apparatus 12 receives the second image M2 and the partition information PN from the transmission interface 11, the display driving apparatus 12 will restore the second image M2 to the first image M1 according to the partition information PN and then output the first image M1 to the panel 14 for displaying.

In this embodiment, the display driving apparatus 12 can include a receiving module 120, an image restoring module 122, a storage module 124, an image processing module 126 and a driving module 128. The receiving module 120 is coupled to the transmission interface 11, the image restoring module 122 and the storage module 124 respectively; the image restoring module 122 is coupled to the receiving module 120, the storage module 124 and the image processing module 126 respectively; the storage module 124 is coupled to the receiving module 120 and the image restoring module 122 respectively; the image processing module 126 is coupled to the image restoring module 122 and the driving module 128 respectively; the driving module 128 is coupled to the panel 14.

When the receiving module 120 receiving the second image M2 and the partition information PN, the receiving module 120 will transmit the second image M2 to the image restoring module 122 and transmit the partition information PN to the storage module 124.

When the image restoring module 122 receives the second image M2, the image restoring module 122 can access the partition information PN and restore the second image M2 to the first image M1 according to the partition information PN, and then output the first image M1 to the image processing module 126. It should be noticed that the image restoring module 122 can perform data volume restoring processing on the second image M2 to restore the second image M2 having smaller data volume to the first image M1 having larger data volume, but not limited to this.

Then, the image processing module 126 will perform the ordinary image processing on the first image M1 and then transmit it to the driving module 128. At last, the driving module 128 will generate a driving signal DS including the first image M1 to the panel 14 to drive the panel 14 to display the first image M1.

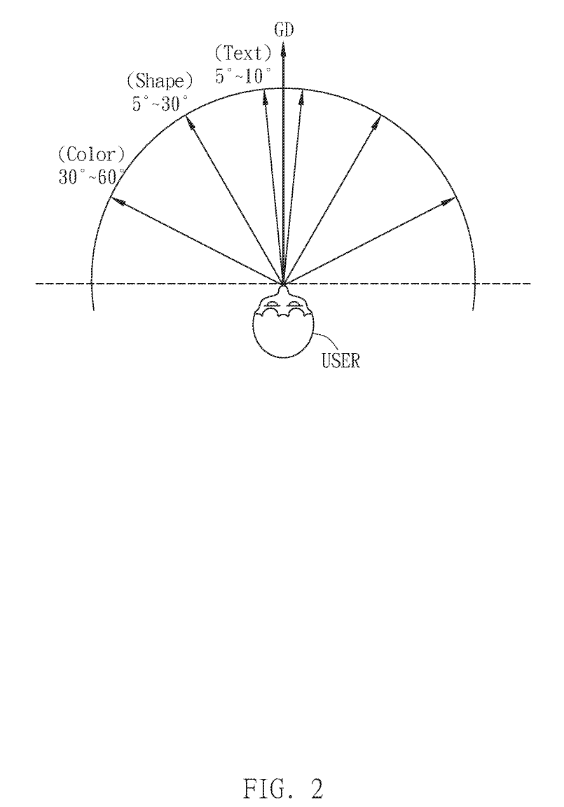

Please refer to FIG. 2. FIG. 2 illustrates a schematic diagram of the visual angles of the surrounding scenery (e.g., text, shape, color, etc.) recognized by the user' eyes. As shown in FIG. 2, it is assumed that the user USER is watching in the gaze direction GD, the visual angle of the user USER through the eyes to distinguish characters, shapes, and colors can be generally 5°˜10°, 5°˜30 ° and 30°˜60°, but not limited to this. That is to say, the visual angle of the human eyes to distinguish the color is usually wider than the visual angle of the human eyes to distinguish the shape, and the visual angle of the human eyes to distinguish the shape is usually wider than the visual angle of the human eyes to distinguish text.

Next, different actual application scenarios will be introduced as follows to explain.

Please refer to FIG. 3. FIG. 3 illustrates a schematic diagram of dividing the panel into display regions centering on a first gaze position on the panel when the human eyes gaze the panel.

As shown in FIG. 3, it is assumed that the first gaze position GP1 on the panel 14 when the human eyes gaze the panel 14, the eye tracking module 100 of the front-end image processing apparatus 10 can trace the first gaze position GP1 of the human eyes EYE through the eye tracking technology and generate the eye tracking information ET to the receiving module 120 according to the first gaze position GP1. The partitioning processing module 102 can refer to FIG. 2 to perform partitioning according to different visual angle ranges centering on the first gaze position GP1.

Taking FIG. 3 as an example, the partition processing module 102 divides the entire display region of the panel into three regions R1˜R3 according to different visual angle ranges centering on the first gaze position GP1, wherein the region R1 is the most clear part distinguishable by the human eyes, then the region R2 and followed by the region R3 again. In this case, the regions R1˜R3 can be defined as “the primary gaze region”, “the secondary gaze region” and “the non-gaze region” of the human eyes EYE respectively, but not limited to this.

It should be noticed that it is only an embodiment that the partition processing module 102 divides the entire display region of the panel into three regions; in fact, the partition processing module 102 can also divide the entire display region of the panel into more regions without specific limitations.

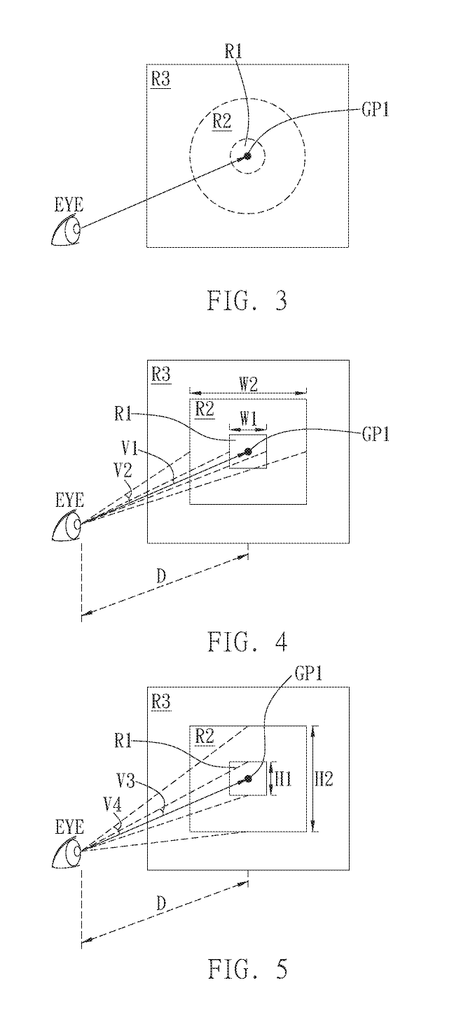

According to the above example, it is assumed that the partition processing module 102 divides the entire display region of the panel into three regions, and the recognition degrees of the visual angles of the human eyes are slightly different in the horizontal direction and the vertical direction; that is to say, the widths and the heights of different regions divided by the partition processing module 102 may be different. Therefore, descriptions in the horizontal direction and the vertical direction will be separately made through FIG. 4 and FIG. 5 respectively.

Please refer to FIG. 4. FIG. 4 illustrates a schematic diagram of obtaining the widths of different display regions according to the horizontal visual angle of the human eyes and the distance between the human eyes and the panel.

As shown in FIG. 4, the first gaze position GP1 of the human eyes EYE can be a pixel of the panel. If the first gaze position GP1 is used as a center and expanded outwards with the horizontal visual angle V1, it may correspond to the horizontal boundary of the region R1, and if the distance between the human eyes EYE and the panel is D, then the width W1 of the region R1 can be calculated based on the distance D and the horizontal visual angle V1. Similarly, if the first gaze position GP1 is used as the center and expanded outwards with the horizontal vision angle V2, and if the distance between the human eyes EYE and the panel is D, then the width W2 of the region R2 can be calculated based on the distance D and the horizontal visual angle V2.

It should be noticed that when the partition processing module 102 divides the entire display region of the panel into more regions, it is so on, and no further explanation is given here.

Please refer to FIG. 5. FIG. 5 illustrates a schematic diagram of obtaining the heights of different display regions according to the vertical visual angle of the human eyes and the distance between the human eyes and the panel.

As shown in FIG. 5, if the first gaze position GP1 is used as a center and expanded outwards with the vertical visual angle V3, it may correspond to the vertical boundary of the region R1 and the distance between the human eyes EYE and the panel is D, then the height H1 of the region R1 can be calculated based on the distance D and the vertical visual angle V3. Similarly, if the first gaze position GP1 is used as the center and expanded outwards with the vertical vision angle V4 and the distance between the human eyes EYE and the panel is D, then the height H2 of the region R2 can be calculated based on the distance D and the vertical visual angle V4.

It should be noticed that when the partition processing module 102 divides the entire display region of the panel into more regions, it is so on, and no further explanation is given here.

From above, it can be found that the partition processing module 102 can divide the first image M1 into different regions R1-R3 according to the eye tracking information ET (e.g., the eye tracking information ET can include the first gaze position GP1 and the distance D between the human eyes EYE and the panel) and obtain the horizontal width and the vertical height of the regions, and then different image processing (e.g., providing different number of bits and resolutions, but not limited to this) can be performed on different regions R1-R3 respectively to generate the second image M2.

For example, if the regions R1-R3 are defined as “the primary gaze region”, “the secondary gaze region” and “the non-gaze region” of the human eyes EYE respectively, then the partition processing module 102 can provide the highest number of bits and resolution to the region R1, provide the medium number of bits and resolution to the region R2 and provide the lowest number of bits and resolution to the region R3.

It should be noticed that the partition image processing that the partition processing module 102 performs on the first image M1 includes performing data volume reduction processing on the first data volume of the first image M1, so that the data volume of the second image M2 generated by the partition processing module 102 will be smaller than the data volume of the original first image M1.

By doing so, the first image M1 originally having larger data volume can be reduced to the second image M2 with smaller data volume by the front-end image processing apparatus 10, and then the second image M2 with smaller data volume can be transmitted to the display driving device 12 through the transmission interface 11. Therefore, the insufficient bandwidth problem of the transmission interface 11 can be effectively improved and good data transmission speed can be maintained.

In addition, the partition processing module 102 can also generate the partition information PN to the display driving apparatus 12 through the transmission interface 11. In this embodiment, the partition information PN can include the information such as the coordinate of the first gaze position GP1, the width W1 and the height H1 of the region R1, the width W2 and the height H2 of the region R2, etc, but not limited to this. The positions of pixels corresponding to the first gaze position GP1 and the number of pixels corresponding to the widths W1-W2 and the heights H1-H2 can be obtained according to the actual width and resolution of the panel, so that the ranges of the regions R1-R3 can be clearly defined.

Next, the position on the panel gazed by the human eyes is moved from the original first gaze position to the second gaze position will be described by the following embodiment.

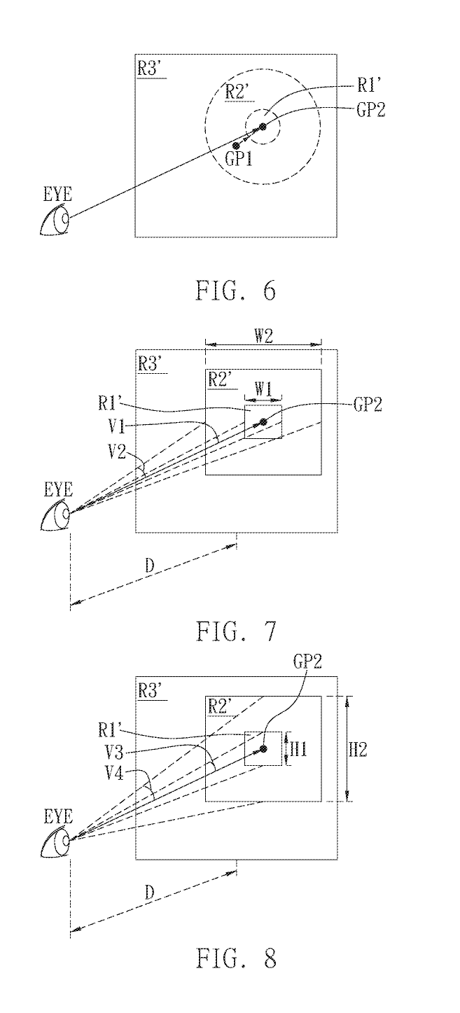

Please refer to FIG. 6. FIG. 6 illustrates a schematic diagram of dividing the panel into display regions centering on the second gaze position GP2 when the position on the panel gazed by the human eyes EYE is moved from the original first gaze position GP1 to the second gaze position GP2.

As shown in FIG. 6, when the position on the panel gazed by the human eyes EYE is moved from the original first gaze position GP1 to the second gaze position GP2, the eye tracking module 100 of the front-end image processing apparatus 10 can track the second gaze position GP2 through the eye tracking technology and generate the eye tracking information ET to the partition processing module 102. The partition processing module 102 can refer to FIG. 2 to perform the partitioning procedure according to different visual angle ranges centering on the second gaze position GP2.

Taking FIG. 6 as an example, the partition processing module 102 divides the entire display region of the panel into three regions R1′-R3′ according to different visual angle ranges centering on the second gaze position GP2, wherein the region R1′ is the most clear part distinguishable by the human eyes, then the region R2′ and followed by the region R3′ again. In this case, the regions R1′-R3′ can be defined as “the primary gaze region”, “the secondary gaze region” and “the non-gaze region” of the human eyes EYE respectively, but not limited to this.

Since the recognition degrees of the visual angles of the human eyes are slightly different in the horizontal direction and the vertical direction; that is to say, the widths and the heights of different regions divided by the partition processing module 102 may be different. Therefore, descriptions in the horizontal direction and the vertical direction will be separately made through FIG. 7 and FIG. 8 respectively.

Please refer to FIG. 7. FIG. 7 illustrates a schematic diagram of obtaining the widths of different display regions according to the horizontal visual angle of the human eyes and the distance between the human eyes and the panel.

As shown in FIG. 7, the second gaze position GP2 of the human eyes EYE can be another pixel of the panel. If the second gaze position GP2 is used as a center and expanded outwards with the horizontal visual angle V1, it may correspond to the horizontal boundary of the region R1′, and if the distance between the human eyes EYE and the panel is D, then the width W1 of the region R1′ can be calculated based on the distance D and the horizontal visual angle Vl. Similarly, if the second gaze position GP2 is used as the center and expanded outwards with the horizontal vision angle V2, and if the distance between the human eyes EYE and the panel is D, then the width W2 of the region R2′ can be calculated based on the distance D and the horizontal visual angle V2.

Please refer to FIG. 8. FIG. 8 illustrates a schematic diagram of obtaining the heights of different display regions according to the vertical visual angle of the human eyes and the distance between the human eyes and the panel.

As shown in FIG. 8, if the second gaze position GP2 is used as a center and expanded outwards with the vertical visual angle V3, it may correspond to the vertical boundary of the region R1′ and the distance between the human eyes EYE and the panel is D, then the height H1 of the region R1′ can be calculated based on the distance D and the vertical visual angle V3. Similarly, if the second gaze position GP2 is used as the center and expanded outwards with the vertical vision angle V4 and the distance between the human eyes EYE and the panel is D, then the height H2 of the region R2′ can be calculated based on the distance D and the vertical visual angle V4.

Another preferred embodiment of the invention is a display driving apparatus. In this embodiment, the display driving apparatus can be a display driving IC used to drive the panel to display the image, but not limited to this.

Please also refer to FIG. 1. As shown in FIG. 1, the display driving apparatus 12 is applied to a virtual reality display system 1 and coupled between a front-end image processing apparatus 10 and a panel 14. The front-end image processing apparatus 10 and the display driving apparatus 12 are coupled through a transmission interface 11.

The front-end image processing apparatus 10 performs a partition image processing on a first image M1 according to an eye tracking information ET and then outputting a second image M2 and a partition information PN to the display driving apparatus 12, wherein the partition information PN is related to the eye tracking information ET and the first image M1, and a second data volume of the second image M2 is smaller than a first volume of the first image M1.

the display driving apparatus 12 can include a receiving module 120, an image restoring module 122, a storage module 124, an image processing module 126 and a driving module 128. The receiving module 120 is coupled to the transmission interface 11, the image restoring module 122 and the storage module 124 respectively; the image restoring module 122 is coupled to the receiving module 120, the storage module 124 and the image processing module 126 respectively; the storage module 124 is coupled to the receiving module 120 and the image restoring module 122 respectively; the image processing module 126 is coupled to the image restoring module 122 and the driving module 128 respectively; the driving module 128 is coupled to the panel 14.

When the receiving module 120 receiving the second image M2 and the partition information PN from the transmission interface 11, the receiving module 120 will transmit the second image M2 to the image restoring module 122 and transmit the partition information PN to the storage module 124.

When the image restoring module 122 receives the second image M2, the image restoring module 122 can access the partition information PN and restore the second image M2 to the first image M1 according to the partition information PN, and then output the first image M1 to the image processing module 126. It should be noticed that the image restoring module 122 can perform data volume restoring processing on the second image M2 to restore the second image M2 having smaller data volume to the first image M1 having larger data volume, but not limited to this.

Then, the image processing module 126 will perform the ordinary image processing on the first image M1 and then transmit it to the driving module 128. At last, the driving module 128 will generate a driving signal DS including the first image M1 to the panel 14 to drive the panel 14 to display the first image M1.

Compared to the prior art, in the virtual reality display system of the invention, the front-end image processing apparatus can be divided into a gaze region and a non-gaze region by using the gaze position on the panel obtained by the eye tracking module and different number of bits and resolutions can be provided to the gaze region and the non-gaze region respectively, such as the higher number of bits and resolution are only provided to the gaze region, while a lower number of bits and resolution are provided to the non-gaze region. In this way, the front-end image processing apparatus can greatly reduce the data volume of the image and then transmit it to the display driving apparatus through the transmission interface. Therefore, the bandwidth required for the transmission interface to transmit the display image can be effectively saved, thereby the insufficient bandwidth of the data transmission interface can be improved and good data transmission speed can be maintained.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A virtual reality display system, comprising:
a front-end image processing apparatus, for performing a partition image processing on a first image according to an eye tracking information and then outputting a second image and a partition information, wherein the partition information is related to the eye tracking information and the first image, and a second data volume of the second image is smaller than a first volume of the first image;
a display driving apparatus, coupled to the front-end image processing apparatus, for restoring the second image to the first image according to the partition information; and
a panel, coupled to the display driving apparatus, for displaying the first image.

2. The virtual reality display system of claim 1, wherein the front-end image processing apparatus comprises:
an eye tracking module, for tracking a gaze position on the panel when human eyes gaze on the panel and generating the eye tracking information according to the gaze position;
a partition processing module, coupled to the eye tracking module, for receiving the first image and the eye tracking information respectively and performing the partition image processing on the first image according to an eye tracking information to generate the second image and the partition information; and
a transmission module, coupled to the partition processing module and the display driving apparatus respectively, for transmitting the second image and the partition information to the display driving apparatus.

3. The virtual reality display system of claim 1, wherein the partition image processing comprises performing a data volume reduction processing on the first data volume of the first image.

4. The virtual reality display system of claim 1, wherein the display driving apparatus comprises:
a receiving module, coupled to the front-end image processing apparatus, for receiving the second image and the partition information;
an image restoring module, coupled to the receiving module, for restoring the second image to the first image according to the partition information; and
a driving module, coupled to the image restoring module and the panel, for generating a driving signal comprising the first image to the panel to drive the panel to display the first image.

5. The virtual reality display system of claim 4, wherein the image restoring module performs a data volume restoring processing on the second data volume of the second image.

6. The virtual reality display system of claim 1, further comprising:
a transmission interface, coupled between the front-end image processing apparatus and the display driving apparatus, for transmitting the second image and the partition information.

7. A display driving apparatus, applied to a virtual reality display system and coupled between a front-end image processing apparatus and a panel, the front-end image processing apparatus performing a partition image processing on a first image according to an eye tracking information and then outputting a second image and a partition information to the display driving apparatus, the partition information being related to the eye tracking information and the first image, and a second data volume of the second image being smaller than a first volume of the first image, the display driving apparatus comprising:
a receiving module, coupled to the front-end image processing apparatus, for receiving the second image and the partition information;
an image restoring module, coupled to the receiving module, for restoring the second image to the first image according to the partition information; and
a driving module, coupled to the image restoring module and the panel, for generating a driving signal comprising the first image to the panel to drive the panel to display the first image.

8. The display driving apparatus of claim 7, wherein the front-end image processing apparatus comprises:
an eye tracking module, for tracking a gaze position on the panel when human eyes gaze on the panel and generating the eye tracking information according to the gaze position;
a partition processing module, coupled to the eye tracking module, for receiving the first image and the eye tracking information respectively and performing the partition image processing on the first image according to an eye tracking information to generate the second image and the partition information; and
a transmission module, coupled to the partition processing module and the display driving apparatus respectively, for transmitting the second image and the partition information to the display driving apparatus.

9. The display driving apparatus of claim 7, wherein the partition image processing comprises performing a data volume reduction processing on the first data volume of the first image.

10. The display driving apparatus of claim 7, wherein the image restoring module performs a data volume restoring processing on the second data volume of the second image.

11. The display driving apparatus of claim 7, wherein the display driving apparatus is coupled to the front-end image processing apparatus through a transmission interface and the transmission interface is used for transmitting the second image and the partition information.
